(19) United States
(12) Patent Application Publication
(10) Pub. No.: US 2020/0158851 A1
(43) Pub. Date: May 21, 2020

(54) RADIO-FREQUENCY DEVICE

(71) Applicant: SHARP KABUSHIKI KAISHA, Sakai City (JP)

(72) Inventor: EIJI SUEMATSU, Sakai City (JP)

(21) Appl. No.: 16/682,539

(22) Filed: Nov. 13, 2019

Related U.S. Application Data
(60) Provisional application No. 62/769,363, filed on Nov. 19, 2018.

(51) Int. Cl. G01S 13/62

(52) U.S. Cl. CPC G01S 13/62

(57) ABSTRACT

An arithmetic processor of a microwave device detects a motion of a target as an amplitude value at given time intervals in accordance with the difference between the frequency of radiation waves and the frequency of reflected waves. The radiation waves are emitted to the target. The reflected waves are reflected from the target. The arithmetic processor determines whether the target is approaching or receding and determines, as a position through which the target has passed, a first-amplitude-value position on the basis of the magnitude relationship between a first amplitude value and a second amplitude value. The first-amplitude-value position is a position at which the first amplitude value is present, and is determined in terms of ranges defined by using the minimum, the maximum, and adjacent two values of the thresholds.

### TECHNICAL FIELD

The present invention relates to a radio-frequency device which is used in a microwave communication device, a microwave radar system, or the like and which includes an antenna.

### BACKGROUND ART

Recently, there has been an increasing demand for detecting, for example, for monitoring, a motion of a moving body including a living body, such as a person or an animal.

PTL 1 discloses a monitoring system of the related art. FIG. 16 illustrates such a monitoring system 900. The monitoring system 900 includes a monitoring camera 911, and/or includes a human detecting sensor for detecting an intruder or a monitoring camera 912 having a human detecting sensor 913. Recently, a sharply increasing number of such monitoring systems have been installed.

The monitoring system 900 is installed on a ceiling 901 or at an upper corner of a room where the ceiling 901 meets a wall 902. The monitoring cameras 911 and 912 may view their surrounding area from an upper position. Typically, the human detecting sensor 913 is an infrared pyroelectric sensor or an active infrared sensor. The human detecting sensor 913, which has a characteristic of using infrared radiation, detects, for example, a person's motion from a high position of a room in which no obstacles are present.

In contrast, PTL 2 discloses a human detecting sensor of the related art. FIG. 17 illustrates such a human detecting sensor 1000. The human detecting sensor 1000 includes a Doppler sensor module 1001, an analog-digital converter (ADC) 1002, a processing unit 1003, and a memory 1004.

The Doppler sensor module 1001 emits electromagnetic waves such as microwaves, and receives reflected waves obtained through reflection from an object such as a person. When the object is a moving body, the frequency of reflected waves is different from that of emitted electromagnetic waves due to the Doppler effect. Therefore, the difference between the frequency of the radiation waves and that of the reflected waves is used to detect an object. The ADC 1002 samples the strength of an analog signal which is output from the Doppler sensor module 1001, and converts it to a digitals signal (output data). The processing unit 1003 processes the output data, which is received from the ADC 1002, of the Doppler sensor module 1001. The processing unit 1003 includes a signal strength comparing unit 1005, a variance comparing unit 1006, and a presuming unit 1007.

The magnitude of the variance of amplitudes of the output data (signal strength) indicates presence or absence of a person, and instability of the variance indicates how active the person is. In view of this, the signal strength comparing unit 1005 and the variance comparing unit 1006 calculate a first threshold and a second threshold, respectively, (the first threshold>the second threshold) on the basis of the variance. The variance comparing unit 1006 compares the amplitude of the output data with the first threshold. In contrast, the variance comparing unit 1006 compares the variance of the amplitudes of the output data with the second threshold. The presuming unit 1007 estimates the state of the person in the space in which the human detecting sensor 1000 is located, on the basis of the comparison results from the signal strength comparing unit 1005 and the variance comparing unit 1006.

Specifically, when amplitudes of the output data are greater than the given first threshold, the presuming unit 1007 resets the presence/absence flag. When the amplitudes are equal to or less than the first threshold and when the variance of amplitudes of the output data is greater than the second threshold, the presuming unit 1007 sets the presence/absence flag to presence. When the amplitudes are equal to or less than the first threshold and when the variance of amplitudes is not greater than the second threshold, if the presence/absence flag has been set to presence, the presuming unit 1007 presumes that the person is resting. In contrast, in this case, if the presence/absence flag has been set to absence, the presuming unit 1007 presumes that no persons are present.

### CITATION LIST

### Patent Literature

[PTL 1] Japanese Unexamined Patent Application Publication No. 2005-277698

[PTL 2] Japanese Unexamined Patent Application Publication No. 2011-215031

### SUMMARY OF INVENTION

### Technical Problem

In the monitoring system 900 disclosed in PTL 1, the monitoring cameras 911 and 912, which are installed at high positions of a room, fail to discriminate the face of a person who comes in or goes out with their face in an unphotographable state, such as an intruder with their face downward or a person whose face is covered. In addition, the monitoring cameras 911 and 912, which are covered with cloth or the like, are unable to perform a function of monitoring a person anymore.

In addition, the configuration of the monitoring system 900 needs multiple cameras and multiple dedicated personal computers (local PCs or remote PCs), resulting in a high cost. Further, installation of the monitoring cameras 911 and 912 causes a privacy problem, resulting in extremely rare implementation in typical home.

The human detecting sensor 913 disclosed in PTL 1 has difficulty in detecting, for example, a person who wears clothes of a color difficult to sense or a person whose motion is slow. The human detecting sensor 913, which is incapable of operating in a high room temperature, has a disadvantage of having a large number of detection failure cases. Further, since the operation area of the human detecting sensor 913 is narrow, multiple human detecting sensors 913 need to be installed for detection in a wide area.

In contrast, the Doppler human detecting sensor 1000 presumes the indoor activity state of a person only to be active or resting. Thus, the human detecting sensor 1000 fails to estimate the amount of activity and the frequency of activities as the amount of activity in each required time.

Further, the configuration of the human detecting sensor 1000, which is installed indoors, has difficulty in discriminating between the approaching state and the receding state of a walking person and in detecting the position of the approaching or receding person.

An object of one aspect of the present invention is to discriminate the approaching state of a moving body from the receding state and detect the position of the approaching or receding moving body.

### Solution to Problem

(1) According to one embodiment of the present invention, a radio-frequency device includes an amplitude-value detecting unit, a comparison unit, and a determination unit. The amplitude-value detecting unit detects a motion of a target as an amplitude value at a given time interval in accordance with a difference between a frequency of a radiation wave and a frequency of a reflected wave. The radiation wave is emitted to the target. The reflected wave is reflected from the target. The comparison unit compares a first amplitude value with a second amplitude value. The first amplitude value is the amplitude value detected this time. The second amplitude value is the amplitude value detected a previous time. The comparison unit compares the first amplitude value with a plurality of thresholds that are set in advance. The determination unit determines whether the target is approaching or receding on the basis of a magnitude relationship between the first amplitude value and the second amplitude value, and determines a first-amplitude-value position as a position which the target has passed. The first-amplitude-value position is a position at which the first amplitude value is present and is determined in terms of ranges defined by using a minimum, a maximum, and adjacent two values of the plurality of thresholds.

(2) According to another embodiment of the present invention, a radio-frequency device includes an amplitude-value detecting unit, a comparison unit, and a determination unit. The amplitude-value detecting unit detects a motion of a target as an amplitude value at a given time interval in accordance with a difference between a frequency of a radiation wave and a frequency of a reflected wave. The radiation wave is emitted to the target. The reflected wave is reflected from the target. The comparison unit compares the amplitude value with a plurality of thresholds so as to select a maximum threshold among the plurality of thresholds as a reference threshold. The plurality of thresholds are set in advance. The maximum threshold is exceeded by the amplitude value. The comparison unit compares a first reference threshold with a second reference threshold. The first reference threshold is the reference threshold selected this time. The second reference threshold is the reference threshold selected a previous time. The determination unit determines whether the target is approaching or receding on the basis of a magnitude relationship between the first reference threshold and the second reference threshold, and determines a first-reference-threshold position as a position which the target has passed. The first-reference-threshold position is a position at which the first reference threshold is present and is determined in terms of ranges defined by using a minimum, a maximum, and adjacent two values of the plurality of thresholds.

(3) According to an embodiment of the present invention, in addition to the configuration of (1) or (2) described above, a radio-frequency device is configured in that the determination unit uses the amplitude value obtained by using an average or a root mean square at a given distance interval, so as to set the plurality of thresholds, and determines a position passed by the target, on the basis of the thresholds.

(4) According to an embodiment of the present invention, in addition to the configuration of any one of (1) to (3) described above, a radio-frequency device is configured in that the determination unit determines whether the target is approaching or receding on the basis of a phase relationship between an I signal and a Q signal which indicate a motion of the target.

(5) According to an embodiment of the present invention, in addition to the configuration of any one of (1) to (4) described above, a radio-frequency device is configured in that the determination unit holds the thresholds used in determination, and detects a frequency of use of the thresholds in each given time period to determine an amount of activity of the target instead of determination as to whether the target is approaching or receding and determination of a passed position of the target.

(6) According to an embodiment of the present invention, in addition to the configuration of any one of (1) to (5) described above, a radio-frequency device is configured in that a band lower than the amplitude value is 0.1 Hz and higher.

(7) According to an embodiment of the present invention, in addition to the configuration of any one of (1) to (6) described above, a radio-frequency device further includes an antenna that has directivity, in which a strong transmit wave is emitted in a traveling direction of the target, so as to emit the transmit wave directly to the target.

(8) According to an embodiment of the present invention, in addition to the configuration of (7) described above, a radio-frequency device is configured in that the antenna has broad directivity in a horizontal direction and has narrow directivity in an elevation-angle direction.

(9) According to an embodiment of the present invention, in addition to the configuration of (7) described above, a radio-frequency device is configured in that the antenna has narrow directivity in a horizontal direction and has broad directivity in an elevation-angle direction.

### Advantageous Effects of Invention

According to one aspect of the present invention, the approaching state of a moving body may be discriminated from the receding state, and the position of the moving body, which is approaching or receding, may be detected.

### BRIEF DESCRIPTION OF DRAWINGS

FIG. 1 is a block diagram illustrating the configuration of a microwave device according to the embodiments of the present invention.

FIG. 2 is a block diagram illustrating the configuration of a signal processor in the microwave device.

FIG. 3A is a plan view of the structure of the microwave device.

FIG. 3B is a section view taken along line D-D in FIG. 3A.

FIG. 4A is a plan view of the microwave device disposed vertically.

FIG. 4B is a diagram illustrating radiation characteristics of the microwave device in the arrangement in FIG. 4A.

FIG. 5 is a block diagram illustrating the configuration of an arithmetic processor of the microwave device.

FIG. 6 is a flowchart of an operational procedure of a digital signal processor of the signal processor.

FIG. 7A is a plan view of the microwave device which is installed horizontally.

FIG. 7B is a diagram illustrating the relationship between thresholds and the position of a moving body which approaches or recedes with respect to the radio-frequency device that is installed in the direction in FIG. 7A.

FIG. 8 is a perspective view of a toilet bowl in which the microwave device illustrated in FIG. 7A is used in operations of opening and closing the cover and the toilet seat.

FIG. 9A is a diagram illustrating change in an IQ amplitude value obtained when the moving body walks.

FIG. 9B is a diagram illustrating the transition state of thresholds selected in accordance with the change in the IQ amplitude value.

FIG. 10 is a flowchart of an operational procedure of a digital signal processor of a microwave device according to a second embodiment of the present invention.

FIG. 11 is a diagram illustrating the principle of determination of approaching or receding based on the phase of the I signal and that of the Q signal, which is performed by a microwave device according to a third embodiment of the present invention.

FIG. 12A is a diagram illustrating determination of approaching, based on the principle in FIG. 11, from a signal curve in the IQ complex plane.

FIG. 12B is a diagram illustrating determination of receding, based on the principle in FIG. 11, from a signal curve in the IQ complex plane.

FIG. 13 is a flowchart of an operational procedure of a digital signal processor based on the principle in FIG. 11.

FIG. 14 is a flowchart of another operational procedure of a digital signal processor based on the principle in FIG. 11.

FIG. 15 is a flowchart of an operational procedure of a digital signal processor of a microwave device according to a fourth embodiment of the present invention.

FIG. 16 is a side view of the configuration of a monitoring system of the related art.

FIG. 17 is a block diagram illustrating the configuration of a human detecting sensor of the related art.

### DESCRIPTION OF EMBODIMENTS

### First Embodiment

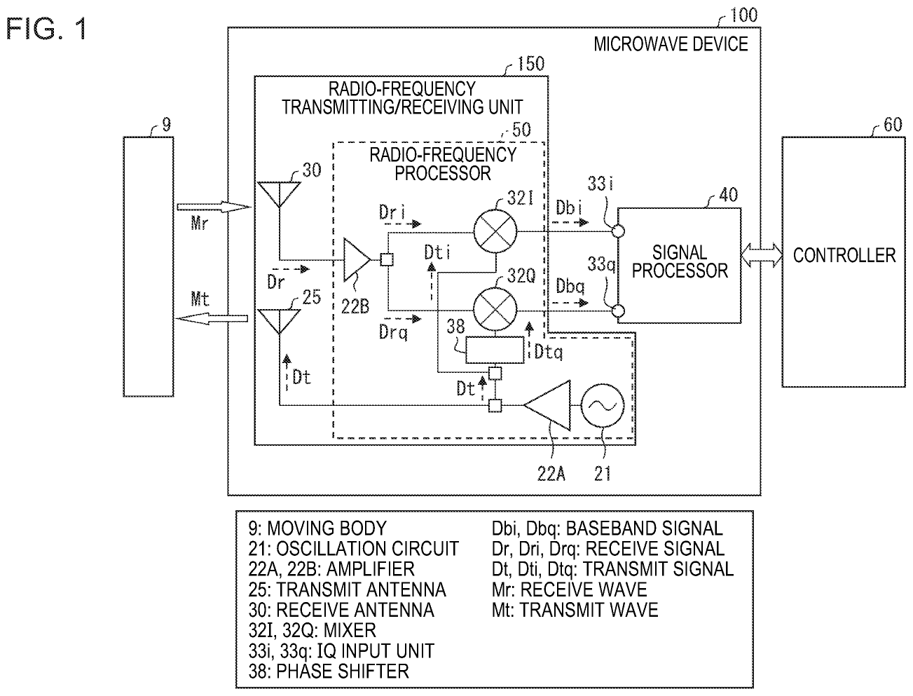

A first embodiment of the present invention will be described below on the basis of FIGS. 1 to 8.

<The Configuration of a Microwave Device 100>

FIG. 1 is a block diagram illustrating the configuration of a microwave device 100 according to the present embodiment.

As illustrated in FIG. 1, the microwave device 100 (radio-frequency device) includes, as main components, a signal processor 40 and a radio-frequency transmitting/receiving unit 150.

The radio-frequency transmitting/receiving unit 150 emits microwaves (radiation waves) to a moving body 9 which is a target, and receives microwaves (reflected waves) produced through reflection from the moving body 9. The radio-frequency transmitting/receiving unit 150 generates the I channel signal and the Q channel signal, which are orthogonal to each other, as signals reflecting motions (body motions) of the moving body 9 through the Doppler shift.

The radio-frequency transmitting/receiving unit 150 includes a transmit antenna 25 (antenna), a receive antenna 30 (antenna), and a radio-frequency processor 50. The radio-frequency processor 50 includes an oscillation circuit 21, amplifiers 22A and 22B, mixers 32I and 32Q, and a 90° phase shifter 38. The radio-frequency processor 50 is implemented as an IC. The radio-frequency processor 50 may be fabricated with discrete components, for example, by using radio-frequency transistors and diodes.

In transmission, the amplifier 22A in the radio-frequency transmitting/receiving unit 150 amplifies a microwave sinusoidal signal (transmit signal) which is output from the oscillation circuit 21, and the transmit antenna 25 emits the amplified transmit signal Dt as microwaves. Transmit waves Mt, which are microwaves emitted in the space, are reflected from the body surface (such as the breast) of the moving body 9. Reflected waves Mr obtained through the reflection contain the Doppler frequency and the Doppler phase which are produced as the Doppler shift corresponding to a body motion and respiratory and cardiac motions of the moving body 9. Thus, the signal (reflected signal) of the reflected waves Mr received by the receive antenna 30 has the amplitude corresponding to the body motion and respiratory and cardiac motions of the moving body 9.

The Doppler frequency is the difference between the frequency of transmit waves and the frequency of receive waves which is caused by the Doppler effect. The Doppler phase is the difference between the phase of transmit waves and the phase of receive waves which is caused by the Doppler effect.

The amplifier 22B amplifies a receive signal Dr received by the receive antenna 30. Amplified receive signals Dri and Drq are input to the mixer 32I on the I channel side and the mixer 32Q on the Q channel side, respectively. For the sake of convenience, the receive signal Dr that is input to the mixer 32I is referred to as the receive signal Dri, and the receive signal Dr that is input to the mixer 32Q is referred to as the receive signal Drq.

The transmit signal Dt amplified by the amplifier 22A is input to the mixer 32I, and is input to the mixer 32Q through the 90° phase shifter 38. For the sake of convenience, the transmit signal Dt that is input to the mixer 32I is referred to as a transmit signal Dti, and the transmit signal Dt that is input to the mixer 32Q is referred to as a transmit signal Dtq.

In the present embodiment, the configuration in which the 90° phase shifter 38 is used to shift the phase of the transmit signal Dtq by 90° with respect to the phase of the transmit signal Dti is described. However, this configuration is not limiting. For example, the configuration in which the 90° phase shifter 38 may be disposed on the input side of the mixer 32Q and in which the phase of the receive signal Drq is shifted by 90° with respect to the receive signal Dri may be employed.

The mixer 32I performs frequency conversion (down-conversion) on the receive signal Dri, and outputs a baseband signal Dbi. The mixer 32Q performs the frequency conversion on the receive signal Drq, and outputs a baseband signal Dbq. Both the baseband signal Dbi on the I channel side and the baseband signal Dbq on the Q channel side are input to the signal processor 40.

Each of the baseband signals Dbi and Dbq is output as a signal containing the Doppler frequency and the Doppler phase caused by a motion of the moving body 9 (for example, a person). The baseband signals Dbi and Dbq are signals in a range about from 0.1 Hz to 20 kHz in the frequency domain.

The speed and amplitude of the reflected waves Mr, which are input to the receive antenna 30, change over time. Thus, the receive signal Dri on the I channel side and the receive signal Drq on the Q channel side are different in phase by 90° instantaneously. However, the progress of the phase of the baseband signal Dbq with respect to the baseband signal Dbi is not constant in accordance with the speed and the direction of the reflected waves Mr. The progress of the phase always changes with time in accordance with a motion of the moving body 9.

<The Configuration of the Signal Processor 40>

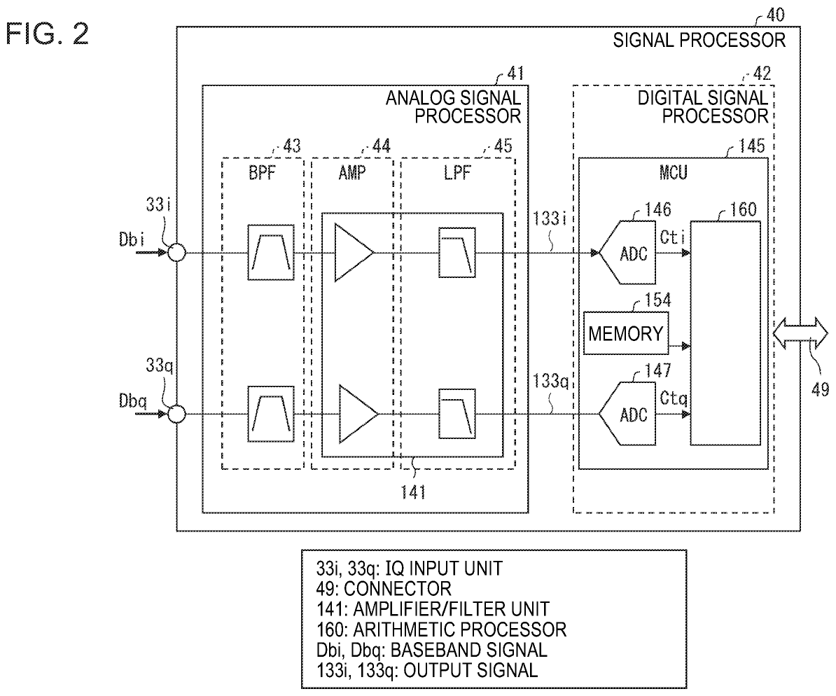

FIG. 2 is a block diagram illustrating the configuration of the signal processor 40.

As illustrated in FIG. 2, the signal processor 40 includes an analog signal processor 41 and a digital signal processor 42.

The baseband signals Dbi and Dbq are input to the analog signal processor 41 through IQ input units 33i and 33q, respectively, of the signal processor 40.

In the analog signal processor 41, a bandpass filter (BPF) 43 limits the band of the baseband signals Dbi and Dbq. The limited band is, for example, from 0.2 Hz to 2000 Hz.

In the analog signal processor 41, an amplifier unit (AMP) 44 amplifies the I signal and the Q signal whose bands have been limited, and a low-pass filter 45 further limits the band of the amplified I signal and Q signal. The amplifier unit 44 and the low-pass filter (LPF) 45 form an amplifier/filter unit 141.

The low-pass filter 45 has, for example, a passband of 300 Hz, and also functions as an anti-aliasing filter for the sampling rate (for example, 2 kHz) with which a signal is subjected to sampling by an MCU 145 of the digital signal processor 42 disposed downstream.

The sampling rate is a sampling rate necessary, for example, for detection of a person or detection of a body motion, and is 2 kHz in this example. To limit the speed to about the walking speed or less (equal to or less than 4 km per hour), in view of the necessary Doppler shift at 24 GHz being about 200 Hz, the passband of the low-pass filter 45 is set to 300 Hz, and, including its lower frequency side, the band width is set to a range from 0.1 Hz to 300 Hz.

This configuration achieves sensitivity characteristics even at 0.1 Hz or higher, as low-frequency band characteristics in the amplitudes of the I signal and the Q signal. Thus, not only is a person's motion or a walking person detected, but also a slow motion of a person's body (for example, typing on a PC or an operation on a smartphone) or a respiratory state may be sensed. Thus, not only walking in the upright position, but also a hand motion in the sitting position, a slight motion of a person's gesture, a respiratory state, or the like may be sensed. Accordingly, the microwave device 100 may sense a motion of a person remaining still.

Output signals 133i and 133q, which are output from the low-pass filter 45, are input to the MCU (Micro Control Unit) 145 of the digital signal processor 42.

In the MCU 145, the AD converters (ADCs) 146 and 147 convert the analog output signals 133i and 133q, respectively, to digital. An arithmetic processor 160 performs given arithmetic processing on an I signal Cti and a Q signal Ctq which have been converted into digital. The arithmetic processing is carried out through the MCU 145 executing a program stored in a memory 154.

The arithmetic processing is, for example, averaging amplitudes and phases of the I signal Cti and the Q signal Ctq (the amplitudes and the phases of a motion of the moving body 9), and comparison with thresholds. As a result of these processes, the arithmetic processor 160 outputs various types of information, such as type information of a motion of the moving body 9, information about the magnitude of the motion, and determination of the approaching state or the receding state of the moving body 9, through a connector 49, for example, as an UART signal.

The UART signal that is output from the MCU 145 is input, for example, through an operation of a user of the microwave device 100, to a controller 60 which is disposed downstream and which is illustrated in FIG. 1.

The arithmetic processing performed by the arithmetic processor 160 will be described in detail below.

<The Implementation Structure and Antenna Characteristics of the Microwave Device 100>

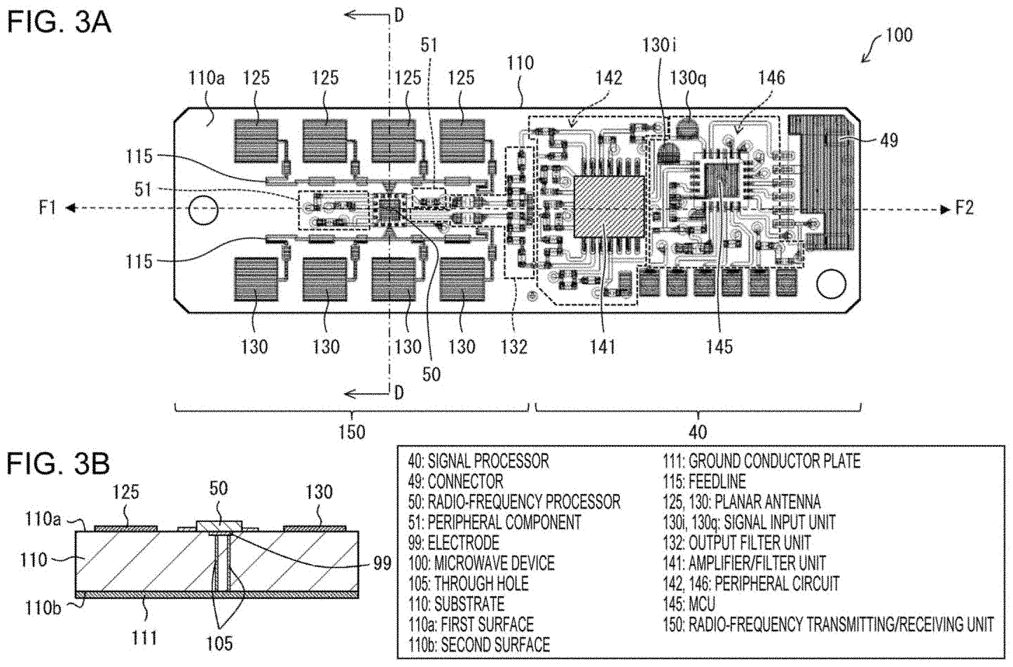

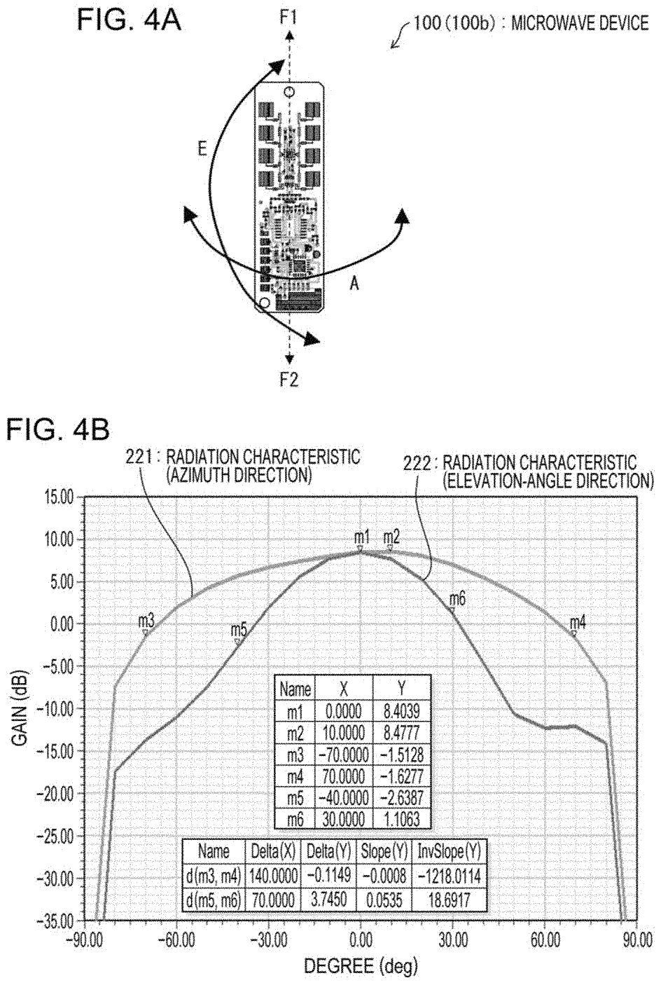

FIG. 3A is a plan view of the structure of the microwave device 100. FIG. 3B is a section view taken along line D-D in FIG. 3A. FIG. 4A is a plan view of the microwave device 100 which is installed vertically. FIG. 4B is a diagram illustrating antenna radiation characteristics of the microwave device 100 in FIG. 4A.

As illustrated in FIGS. 3A and 3B, the radio-frequency transmitting/receiving unit 150 and the signal processor 40 are mounted on a first surface 110a of a rectangular substrate 110.

The radio-frequency transmitting/receiving unit 150 includes multiple planar antennas 125 (antennas) for transmission, multiple planar antennas 130 (antennas) for reception, feedlines 115, the radio-frequency processor 50, peripheral components 51 for the radio-frequency processor 50, and an output filter unit 132. The radio-frequency processor 50 is mounted on the first surface 110a as an MMIC (Monolithic Microwave Integrated Circuit). On the first surface 110a, wires and components for connecting the units to each other are disposed.

The signal processor 40 includes the amplifier/filter unit 141, a peripheral circuit 142 for the amplifier/filter unit 141, the MCU 145, and a peripheral circuit 146 for the MCU 145. The signal processor 40 includes signal input units 130i and 130q. The output signals 133i and 133q, which are output from the amplifier/filter unit 141, are input to input terminals of the MCU 145 through the signal input units 130i and 130q, respectively.

As illustrated in FIG. 3B, the substrate 110 is provided with a ground conductor plate 111 which is made of a planar conductor and which is formed on a second surface 110b located opposite the first surface 110a. Through holes 105 are formed in the substrate 110. The ground conductor plate 111 is electrically connected to an electrode 99, which is formed on the first surface 110a side, through the through holes 105. The electrode 99 is electrically connected to the ground terminal of the radio-frequency processor 50. Wires for power supply and the like are provided on the second surface 110b.

The planar antennas 125 and 130, the substrate 110 (dielectric substrate), and the ground conductor plate 111 form microstrip patch antennas. The planar antennas 125 and 130 function as patch devices in the microstrip patch antennas. The feedlines 115 form microstrip lines. Adjusting the length, the width, and the position of the feedline 115 causes the input impedance to be controlled.

As illustrated in FIG. 4A, when the microwave device 100 is disposed lengthwise, the longitudinal direction (F1-F2 direction) of the substrate 110 matches the vertical direction, and the width direction of the substrate 110 matches the horizontal direction. Thus, the planar antennas 125 are also arranged lengthwise in a line; the planar antennas 130 are also arranged lengthwise in a line.

In the microwave device 100 (100b) disposed as described above, the planar antennas 125 and 130 exhibit radiation characteristics 221 and 222 in FIG. 4B. The radiation characteristic 221 is a radiation characteristic having a beam width (±70°) of broad directivity in the horizontal direction (azimuth direction). The radiation characteristic 222 is a radiation characteristic having a radiation beam width (±35°) narrowed in the F1-F2 direction (elevation-angle direction).

<The Moving-Body Detection Process>

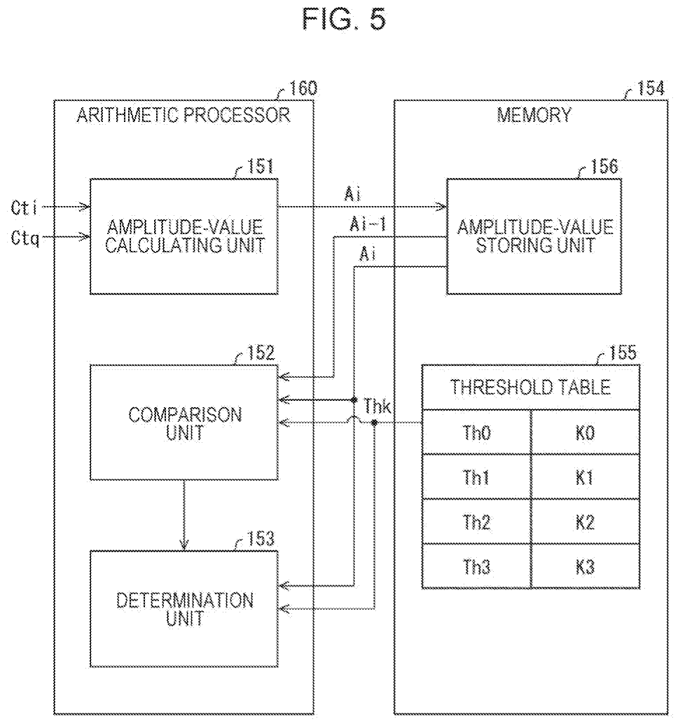

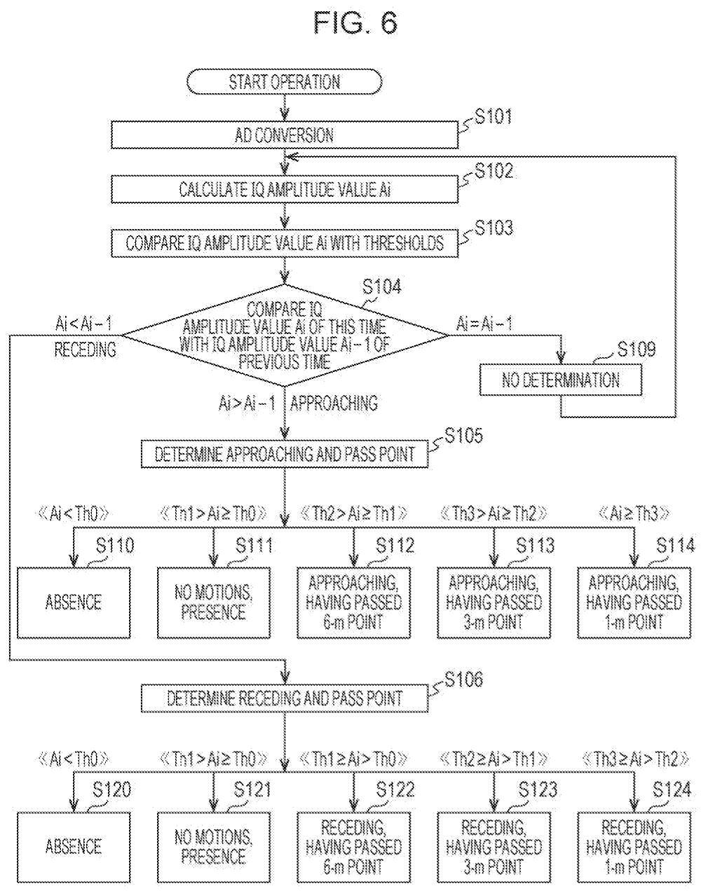

The process, which is performed by the microwave device 100, of detecting the moving body 9 will be described. FIG. 5 is a block diagram illustrating the configuration of the arithmetic processor 160. FIG. 6 is a flowchart of an operational procedure of the digital signal processor 42.

Determination as to whether a person is approaching or receding and determination of the pass point (passed position) will be described below.

As illustrated in FIG. 6, the AD converters 146 and 147 in the MCU 145 of the digital signal processor 42 convert the analog I signal 133i and the analog Q signal 133q into digital (AD conversion), and generate the digital I signal Cti and the digital Q signal Ctq (step S101). The AD converters 146 and 147 perform, for example, fast-sampling (0.5 millisecond) of 2 kHz as described above, on the analog I signal 133i and the analog Q signal 133q.

As illustrated in FIG. 5, the arithmetic processor 160 of the MCU 145 includes an amplitude-value calculating unit 151 (amplitude-value detecting unit). The amplitude-value calculating unit 151 calculates the IQ amplitude value Ai (an array value) (step S102). Specifically, the amplitude-value calculating unit 151 obtains absolute amplitude values of the I signal Cti and the Q signal Ctq, and calculates the average of 200 absolute values for the I signal Cti which are obtained through 0.5-millisecond sampling and the average of 200 absolute values for the Q signal Ctq which are obtained through 0.5-millisecond sampling, that is, the averages of data at time intervals Tav (=0.1 second). Then, the amplitude-value calculating unit 151 obtains the average of the calculated I signal value and the calculated Q signal value, thus calculating the IQ amplitude value Ai. The amplitude-value calculating unit 151 causes an amplitude-value storing unit 156 of the memory 154 to store the calculated IQ amplitude value Ai (amplitude value). In this example, the example in which the time interval Tav for obtaining the IQ amplitude value Ai is 0.1 second. For example, Tav may be 0.05 second or 0.02 second so that values for a fast motion may be obtained or fine intervals for pass point detection may be set.

The amplitude-value calculating unit 151 may compute the root mean square of the I signal Cti and the Q signal Ctq, thus calculating the IQ amplitude value Ai. Specifically, the root mean square may be calculated by using the expression below.

Ai=√((I×I+Q×Q)/2)

In the expression above, I represents the value of the I signal Cti; Q represents the value of the Q signal Ctq.

Then, a comparison unit 152 included in the arithmetic processor 160 compares thresholds Thi (for example, four values of thresholds Th0 to Th3), which are set in a threshold table 155 included in the memory 154, with the IQ amplitude value Ai (step S103). Setting the thresholds Th0 to Th3 will be described in detail below.

After that, the comparison unit 152 reads, for comparison, the IQ amplitude value Ai (first amplitude value), which is obtained (detected) in this process, and the IQ amplitude value Ai-1 (second amplitude value), which is obtained (detected) in the previous process (step S104). The IQ amplitude value Ai (first amplitude value) and the IQ amplitude value Ai-1 (second amplitude value) are stored in the amplitude-value storing unit 156 of the memory 154.

If the comparison unit 152 determines that the IQ amplitude value Ai is greater than the IQ amplitude value Ai-1, a determination unit 153 included in the arithmetic processor 160 performs determination as to approaching and the pass point (step S105). If the comparison unit 152 determines that the IQ amplitude value Ai is less than the IQ amplitude value Ai-1, the determination unit 153 performs determination as to receding and the pass point (S106). If the comparison unit 152 determines that the IQ amplitude value Ai is equal to the IQ amplitude value Ai-1, the determination unit 153 does not perform determination as to approaching and receding and determination of the pass point (step S109). In this case, the process proceeds to step S102, and the next process is performed.

In step S105, the determination unit 153 determines in which range the obtained IQ amplitude value Ai is present. The ranges are defined with the maximum, the minimum, and two adjacent values of the thresholds Th0 to Th3. On the basis of the determination result, the determination unit 153 performs five types of determination as to approaching, which are indicated by (1) to (5) described below (steps S110 to S114).

(1) Ai<Th0: absence (step S110)

(2) Th1>Ai≥Th0: presence, no motions (step S111)

(3) Th2>Ai≥Th1: approaching, having passed the 6-m point (step S112)

(4) Th3>Ai≥Th2: approaching, having passed the 3-m point (step S113)

(5) Ai≥Th3: approaching, having passed the 1-m point (step S114)

In step S106, the determination unit 153 determines in which range the obtained IQ amplitude value Ai is present. The ranges are defined with the maximum, the minimum, and two adjacent values of the thresholds Th0 to Th3. On the basis of the determination result and the relationship with the thresholds Th0 to Th3, the determination unit 153 performs five types of determination as to receding, which are indicated by (1) to (5) described below (steps S120 to S124).

(1) Th3≥Ai>Th2: receding, having passed the 1-m point (step S124)

(2) Th2≥Ai>Th1: receding, having passed the 3-m point (step S123)

(3) Th1≥Ai>Th0: receding, having passed the 6-m point (step S122)

(4) Th1>Ai≥Th0: presence, no motions (step S121)

(5) Ai<Th0: absence (step S120)

The receding cases, (3) Th1≥Ai>Th0 and (4) Th1>Ai≥Th0, overlap each other in the range of Thi>Ai>Th0. In the (3) case, the determination unit 153 determines that the pass point of the moving body 9 is the 6-m point, from Ai=Th1. In the (4) case, the determination unit 153 determines that the moving body 9 is present, from Ai=Th0.

In the digital signal processing performed in the process procedure, as described above, the I signal Cti and the Q signal Ctq are obtained as 0.5-millisecond signals in the 2-kHz sampling. However, in the present embodiment, the IQ amplitude value Ai of the I signal Cti and the Q signal Ctq is obtained for every 100 milliseconds. Thus, the average of 200 values for the I signal Cti is obtained, and the average of 200 values for the Q signal Ctq is obtained, thus obtaining the IQ amplitude value Ai.

The time interval Tav is adjusted appropriately by using the highest speed and the detection distance interval of the pass point, which is described below, for a motion of the moving body 9. The time interval Tav is, as described above, a period in which the amplitude values of the I signal Cti and the Q signal Ctq are averaged to obtain the IQ amplitude value Ai from the I signal Cti and the Q signal Ctq.

The approaching or receding and the pass point, which are determined as described above, are output as a communication signal (for example, an UART signal) of the MCU 145. The thresholds Thi in the threshold table 155 are input by the MCU 145 by using the UART communication such that appropriate values may be input in advance on the basis of a user's evaluation in accordance with the environment in use.

<Examples of Determination of the Pass Point>

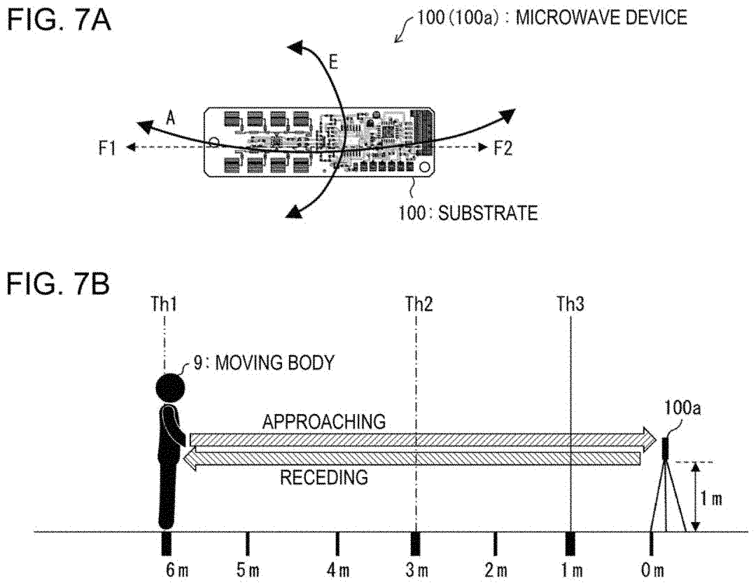

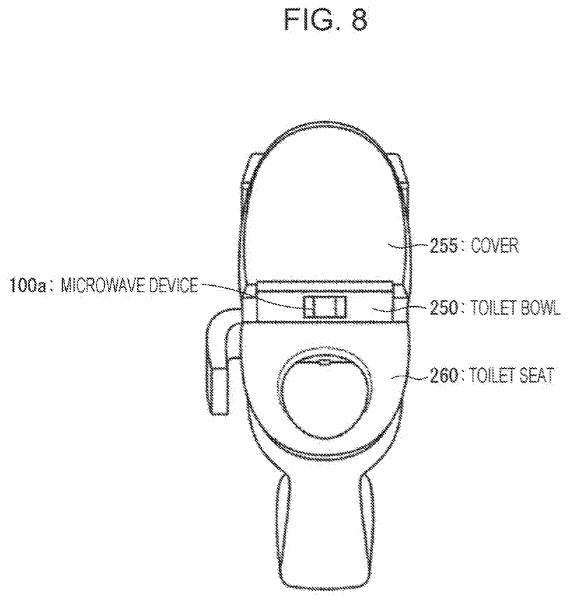

Another arrangement of the microwave device 100 will be described. FIG. 7A is a plan view of the microwave device 100 which is installed horizontally. FIG. 7B is a diagram illustrating the relationship between the thresholds and the position of the moving body 9 approaching or receding with respect to the microwave device 100 which is installed in the direction in FIG. 7A. FIG. 8 is a perspective view of a toilet bowl 250 in which the microwave device 100 illustrated in FIG. 7A is used in the operations of opening and closing a cover 255 and a toilet seat 260. The cover 255 is made of resin. Thus, radio waves may pass through the closed cover 255.

In this example, as illustrated in FIG. 7A, the microwave device 100 is rotated by 900 relative to the longitudinal arrangement (the microwave device 100b in FIG. 4A) so that the planar antennas 125 and 130 are arranged in lines in the transverse direction (horizontal direction) (a microwave device 100a). The planar antennas 125 and 130 having such an arrangement have the elevation-angle direction and the azimuth direction which are inverted compared with those in the microwave device 100b, and exhibit a narrow directional characteristic in the azimuth direction, while exhibiting a broad directional characteristic in the elevation-angle direction.

As illustrated in FIG. 7B, the microwave device 100a is disposed near the arrival point (goal point) in determination of the pass point of the moving body 9. This enables which pass point is passed by the moving body 9 (person), who walks, to be determined efficiently with higher accuracy.

This example describes a determination example of the case in which the moving body 9 moves (recedes) from the 0-m point to the 6-m point at a walking speed of about 0.6 m/s (2.2 km/h) and in which the moving body 9 then stays still temporarily and moves (approaches) from the 6-m point to the 0-m point.

For example, in determination of the pass point of a person who walks in a given indoor area, the microwave device 100a emits radio waves from the planar antennas 125 and 130 only to an area around the walking person. This achieves reduction of unnecessary reflected radio waves from the surrounding area other than the walking person. Thus, the position of the walking person in the area may be detected with higher accuracy.

For example, as illustrated in FIG. 8, the microwave device 100a, which is attached to the toilet bowl 250, may be used in automatic opening and closing of the cover 255 in accordance with the position of a person approaching or receding. The microwave device 100a is disposed in the direction from the posterior to the anterior of the toilet bowl 250 so as to have the directional characteristics of the planar antennas 125 and 130. In addition, the microwave device 100a may detect a motion of a person with radio waves passing through the cover 255 of the toilet bowl 250 in the closed state.

When a person approaches the 1-m point from the toilet bowl 250, the microwave device 100a determines that the pass point is the 1-m point. For example, the controller 60 exerts control so that the cover 255 is opened in response to the determination. Further, if a threshold for determining the state of standing for a while is set, when it is determined that the IQ amplitude value Ai is equal to or greater than the threshold, the controller 60 may cause the toilet seat 260 to rise automatically for males. Furthermore, if the IQ amplitude value Ai is determined to be less than the threshold, the controller 60 may cause the toilet seat 260 to go down or cause the cover 255 to be closed.

In the present embodiment, the example in which four planar antennas 125 for transmission, which are arranged in line, and four planar antennas 130 for reception, which are arranged in line, are used is described. This is because the planar antennas 125 and 130, which have directivity of strong emission in the forward direction (the direction in which the moving body 9 travels), emit radiation waves to a human body directly, and receive reflected waves directly from the human body. This configuration may further include devices added thereto, and/or may include a dielectric antenna, a lens antenna, or the like embedded therein. Thus, the antenna directivity may be further narrowed down.

A small antenna using a dielectric block or a dielectric lens, which provides strong emission in the forward direction, is easily incorporated into a device, and enables suppression of influence from radiated waves from the rear and influence from reflection from walls, the ceiling, and the floor. Thus, the state in which unnecessary reflected radio waves function as noise which serves as obstacles of the determination is avoided. The pass point of a person who is approaching or receding with respect to a target position may be determined with more certainty.

<An Example of Determination as to Approaching and Receding>

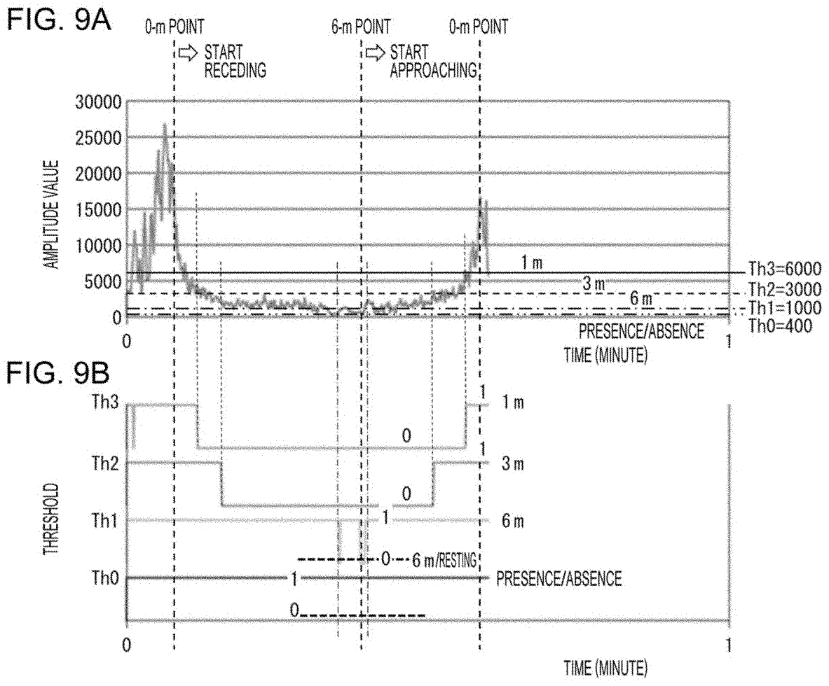

An example of actual determination as to approaching and receding, using the microwave device 100a, will be described. FIG. 9A is a diagram illustrating change in the IQ amplitude value Ai obtained when the moving body 9 walks. FIG. 9B is a diagram illustrating the transition state of thresholds selected in accordance with the change in the IQ amplitude value Ai.

In FIG. 9A, the horizontal axis represents time (minute) from zero to one minute. In FIG. 9A, the vertical axis represents the average of the IQ amplitude values Ai (absolute values). It is assumed that a person (adult) walks indoors typically at 0.6 m/s (about 2.2 km/h). FIG. 9A illustrates data obtained by measuring the amplitude value in approaching or receding at the speed in the distance from 0 m to 6 m from the microwave device 100a which is located inside a room. The threshold Th1 is set to zero at the distance of 6 m from the microwave device 100a when the person stays still in the upright position.

The thresholds Th1 to Th3 are set in advance, and are recorded in the threshold table 155. Specifically, the thresholds Th1 to Th3 are set as follows. An average adult having a height of 170 cm and a breadth of their shoulders of 50 cm passes through the 6-m point, the 3-m point, and the 1-m point repeatedly, for example, five times or more, and the obtained averages are set.

In contrast, when the threshold Th0 is used for detection of presence or absence in a room, the threshold Th0 is set as follows. The microwave device 100a is operated in advance in the room in which no persons are present, and the amplitude value is measured. This value to which an appropriate margin is added is set. In the present embodiment, since the amplitude value of the microwave device 100a is 180 in a room in which no persons are present, the threshold for presence or absence is set to 400.

In this example, the thresholds Th0 to Th3 are set as illustrated in Table 1.

TABLE 1

| Threshold | Value | Determination |
|---|---|---|
| Th0 | K0: 400 | presence or absence |
| Th1 | K1: 1000 | having passed through the 6-m point |
| Th2 | K2: 3000 | having passed through the 3-m point |
| Th3 | K2: 6000 | having passed through the 1-m point |

FIG. 9B illustrates the state in which the thresholds Th0 to Th3 in the threshold table 155 are compared with the amplitude values in FIG. 9A, and in which the transition states of the thresholds Th0 to Th3 are changed from 0 to 1 in accordance with whether or not the amplitude value exceeds the thresholds Th0 to Th3. The thresholds Th0 to Th3 are set in accordance with the amplitude value.

In the present embodiment, for example, the amplitude value for a person who walks at the speed of 0.6 m/s is measured at 0.1-second intervals. This indicates that the amplitude value is measured at 6-cm intervals. However, in the case where the moving body 9 is a person, a fluctuation about 20 cm occurs as a motion of a walking person. This indicates that the determination interval is about 20 cm. Shortening the time interval Tav for obtaining the IQ amplitude value Ai enables application to a faster motion.

### Effects of the Present Embodiment

The microwave device 100 according to the present embodiment receives reflected waves of radiation waves emitted to the moving body 9, and detects a motion of the human body as a detected amplitude value at every given time on the basis of the signal of the reflected waves from a Doppler sensor. In addition, the microwave device 100 compares the amplitude value with multiple thresholds which are set in advance. The microwave device 100 determines whether the moving body 9 is approaching or receding on the basis of the magnitude relationship, and determines the pass point of the moving body 9 on the basis of the degree of change in the amplitude value.

In the configuration, multiple thresholds are obtained in advance on the basis of measurement and evaluation. For example, the second threshold is set to 1000 for the approach distance of 6 m; the third threshold is set to 3000 for the approach distance of 3 m; and the fourth threshold is set to 6000 for the approach distance of 1 m. The first threshold is set to 400 for the state in which no persons are present. In addition, it is assumed that the case of being equal to or greater than the first threshold of 400 indicates presence of a person in a room.

For example, a person of 1 m 70 cm and a weight of 60 kg walking at a typical speed (2 to 3 km/h: about 0.6 m/s) approaches or recedes indoors. The amplitude calculating unit calculates the IQ amplitude value Ai of a body motion of the person. The comparison unit compares the IQ amplitude value Ai with the thresholds which are set as described above. The determination unit estimates the passed position approximately on the basis of which threshold is exceeded by the IQ amplitude value Ai. When an increasing IQ amplitude value Ai is obtained at a given time interval, the determination unit may determine the approaching state. When a decreasing IQ amplitude value Ai is obtained, the determination unit may determine the receding state. Thus, the direction (approaching or receding) in which a moving body (such as a person) moves may be differentiated. At the same time, the position of the moving body approaching or receding may be detected.

In determination of the pass point, the microwave device 100 uses the IQ amplitude value Ai, which is obtained through the average of IQ amplitude values Ai or the IQ root mean square at a given distance interval (for example, an interval of 1.3 cm to 1 m), so as to set the multiple thresholds and determine the pass point of the moving body 9.

According to the configuration, the IQ amplitude value Ai for both the I signal and the Q signal has a two-channel configuration of the I channel and the Q channel using the 90° phase shifter 38. Thus, a signal that has the Doppler shift and that is output from the microwave device 100 is detected with a sine wave in the I channel and is detected with a cosine wave in the Q channel. Therefore, in detection of the I signal and the Q signal, depending on the detection distance, even at a null point which indicates zero in detection in the I channel with sin (0°), detection in the Q channel is performed with cos (0°), and the value is equal to one. Thus, they are correlative to each other with respect to the distance. The root mean square of the I signal and the Q signal or the average of the absolute values of the amplitude values of the I signal and the Q signal (IQ amplitude value Ai) is used, achieving stable detection with higher accuracy. Use of the IQ amplitude value Ai enables determination, for example, of the pass point of the moving body 9 at intervals of 1.25 cm to 100 cm when the frequency 24-GHz band, whose wavelength is 1.25 cm, is used.

The microwave device 100 includes the planar antennas 125 and 130 having broad directivity in the horizontal direction and having narrow directivity in the elevation-angle direction. Specifically, the microwave device 100 is disposed such that the planar antennas 125 and 130 are arranged in the longitudinal direction.

Thus, when the microwave device 100 is used as a human detecting sensor detecting a person's motion, the planar antennas 125 and 130 are disposed on the indoor wall side. This achieves broad directivity in the horizontal direction and narrow directivity in the elevation-angle direction. In addition, reflection from the indoor ceiling or walls may be used efficiently, achieving a directional characteristic which is broader than the radiation angle obtained from the radiation pattern of the antenna itself.

The microwave device 100 includes the planar antennas 125 and 130 having narrow directivity in the horizontal direction and having broad directivity in the elevation-angle direction. Specifically, the microwave device 100 is disposed such that the planar antennas 125 and 130 are arranged in the horizontal direction.

Thus, the microwave device 100 is disposed near the goal point used in determination as to passing. This enables the pass point of a walking person to be determined efficiently with higher accuracy. That is, when the position of a person walking indoors is to be detected, radio waves are emitted from an antenna only to a surrounding area of the walking person, and unnecessary reflected waves from a surrounding area other than the walking person are reduced, achieving detection of the position in the area with higher accuracy.

In addition, radiation waves from the planar antennas 125 and 130 hardly expand in the horizontal direction. Thus, in a room, such as a hotel room, a living room, a toilet, or the like, leakage of radio waves to adjacent rooms through walls may be suppressed.

### Second Embodiment

A second embodiment of the present invention will be described below by referring to FIGS. 1, 2, 5, and 10. For convenience of description, components having the same functions as those of components in the first embodiment are designated with the same reference numerals, and will not be described.

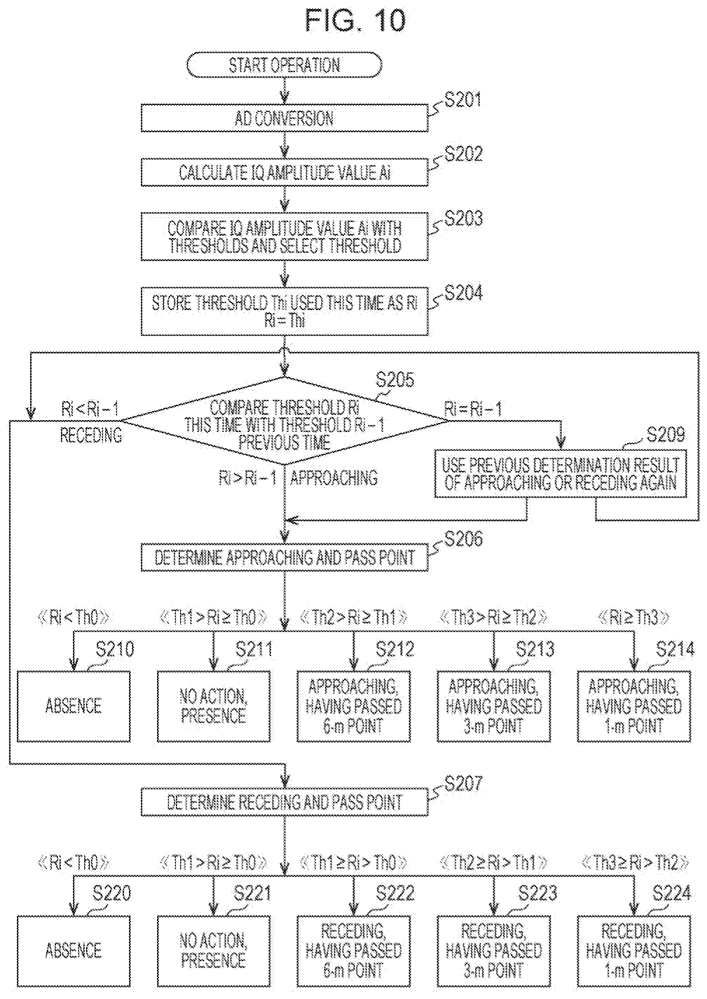

Like the microwave device 100 according to the first embodiment, the microwave device 100 according to the present embodiment has the configuration illustrated in FIGS. 1 and 2. Like the first embodiment, but excluding a part of it, the microwave device 100 according to the present embodiment determines approaching or receding and the pass point. In the present embodiment, functions different from those in the first embodiment will be described by referring to FIG. 10.

<The Moving-Body Detection Process>

The process of detecting the moving body 9, which is performed by the microwave device 100, will be described. FIG. 10 is a flowchart of an operational procedure of the digital signal processor 42 of the microwave device 100 according to the present embodiment.

As illustrated in FIG. 10, steps S201 and S202 are the same processes as steps S101 and S102, respectively, in the flowchart in FIG. 6. However, in step S202, unlike step S102, the amplitude-value calculating unit 151 does not store the calculated IQ amplitude value Ai in the memory 154. This is because, in the next process, the IQ amplitude value Ai is not compared with the IQ amplitude value Ai+1 obtained in the next process.

Like step S103 in FIG. 6, the comparison unit 152 of the arithmetic processor 160 in FIG. 5 compares the IQ amplitude value Ai with the thresholds Thi in the threshold table 155 included in the memory 154, and selects the maximum threshold Thi exceeded by the IQ amplitude value Ai (step S103). The comparison unit 152 stores, as the reference threshold Ri, the selected threshold Thi in an array included in the memory 154, which is not illustrated in FIG. 5 (step S204).

After that, the comparison unit 152 reads, for comparison, the reference threshold Ri (first reference threshold), which has been selected in this process, and the reference threshold Ri-1 (second reference threshold), which was selected in the previous process, from the memory 154 (step S205). If the comparison unit 152 determines that the reference threshold Ri is greater than the reference threshold Ri-1, the determination unit 153 of the arithmetic processor 160 determines approaching and the pass point (step S206). If the comparison unit 152 determines that the reference threshold Ri is less than the reference threshold Ri-1, the determination unit 153 determines receding and the pass point (step S207). Further, if the comparison unit 152 determines that the reference threshold Ri is equal to the reference threshold Ri-1, the determination unit 153 uses the determination result in the previous process again (step S209). In this case, if the determination result in the previous process indicates approaching, the process proceeds to step S206. If the determination result in the previous process indicates receding, the process proceeds to step S207.

In step S206, the determination unit 153 determines in which range the obtained reference threshold Ri is present. The ranges are defined by using the maximum, the minimum, and two adjacent values of the thresholds Th0 to Th3. On the basis of the determination result, the determination unit 153 performs five types of determination as to approaching, which are indicated by (1) to (5) described below (steps S210 to S214). The relationship between the reference threshold Ri and the thresholds Th0 to Th3 is obtained in advance by the comparison unit 152 comparing both.

(1) Ri<Th0: absence (step S210)

(2) Th1>Ri≥Th0: presence, no motions (step S211)

(3) Th2>Ri≥Th1: approaching, having passed the 6-m point (step S212)

(4) Th3>Ri≥Th2: approaching, having passed the 3-m point (step S213)

(5) Ri≥Th3: approaching, having passed the 1-m point (step S214)

In step S207, the determination unit 153 determines in which range the obtained reference threshold Ri is present. The ranges are defined by using the maximum, the minimum, and two adjacent values of the thresholds Th0 to Th3. On the basis of the determination result, the determination unit 153 performs five types of determination as to receding, which are indicated by (1) to (5) described below (steps S220 to S224).

(1) Th3≥Ri>Th2: receding, having passed the 1-m point (step S224)

(2) Th2≥Ri>Th1: receding, having passed the 3-m point (step S223)

(3) Th1≥Ri>Th0: receding, having passed the 6-m point (step S222)

(4) Th1>Ri≥Th0: presence, no motions (step S221)

(5) Ri<Th0: absence (step S220)

The receding cases, (3) Th1≥Ri>Th0 and (4) Th1>Ri≥Th0, overlap each other in the range of Th1>Ri>Th0. In the case of (3), the determination unit 153 determines that the pass point of the moving body 9 is the 6-m point from Ri=Th1. In the case of (4), the determination unit 153 determines that the moving body 9 is present in a room from Ai=Th0.

### Effects of the Present Embodiment

In the process procedure, the difference from the first embodiment is that the reference threshold Ri is used. Specifically, the arithmetic processor 160 selects one of the thresholds Thi through comparison with the IQ amplitude value Ai that is obtained directly. On the basis of the result of comparison of the reference threshold Ri, which has been selected in this process, with the reference threshold Ri-1, which was selected in the previous process, the arithmetic processor 160 determines approaching or receding. The arithmetic processor 160 determines the pass point on the basis of the reference threshold Ri which has been selected in this process.

The microwave device 100 according to the first embodiment compares the IQ amplitude value Ai, which is obtained directly through actual measurement, with the thresholds Th1. The IQ amplitude value Ai may be compatible with a continuous and constant motion of a person. However, in the case where discontinuous approaching or receding is performed while, for example, a person walks at a varying speed or stops, the IQ amplitude value Ai obtained from the person as the moving body 9 increases and decreases. Unlike the case of approaching or receding at a continuous and constant speed, the pass point determined on the basis of the magnitude relationship between the IQ amplitude value Ai and the thresholds Thi is not accurate.

The microwave device 100 according to the present embodiment compares the reference threshold Ri-1, which was selected in the previous process, with the reference threshold Ri, which has been selected in this process, at given time intervals. If the comparison result indicates that the reference threshold Ri is greater than the reference threshold Ri-1, the microwave device 100 determines approaching. If the reference threshold Ri is less than the reference threshold Ri-1, the microwave device 100 determines receding.

The reference threshold Ri, which has been newly obtained in this process, is used to determine the pass point. Thus, the pass point of a person, who is approaching or receding discontinuously while the person changes their walking speed or stops, may be determined.

### Third Embodiment

A third embodiment of the present invention will be described below by referring to FIGS. 1, 2, 5, and 11 to 13. For convenience of description, components having the same functions as those in the first and second embodiments are designated with the same reference numerals, and will not be described.

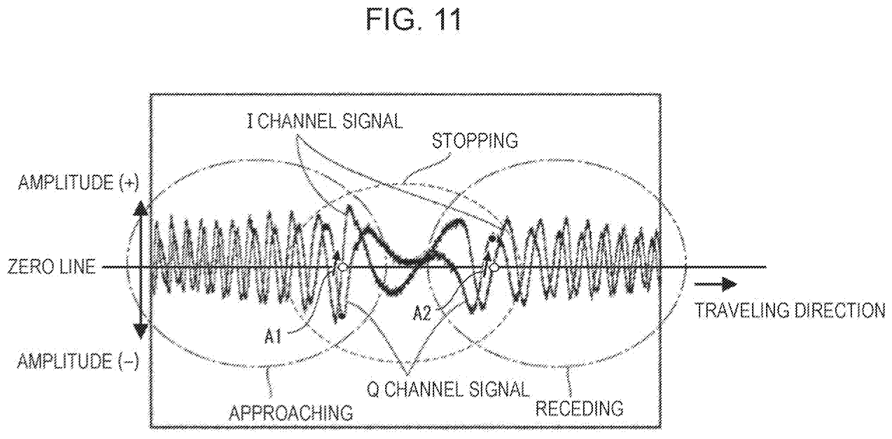

Like the microwave device 100 according to the first embodiment, the microwave device 100 according to the present embodiment has the configuration illustrated in FIGS. 1 and 2. Like the first embodiment, excluding a part of it, the microwave device 100 according to the present embodiment determines approaching or receding and determines the pass point. In the present embodiment, functions different from those in the first and second embodiments will be described by referring to FIGS. 11 to 13.

In the present embodiment, approaching or receding is determined on the basis of the phases of the I signal and the Q signal, not on the basis of an increase or decrease of the IQ amplitude value Ai or an increase or decrease of the obtained reference threshold Ri.

<The Phase Relationship Between the I Signal and the Q Signal>

Determination of approaching or receding based on the phases of the I signal and the Q signal will be described. FIG. 11 is a diagram illustrating the principle of determination of approaching or receding based on the phases of the I signal and the Q signal, which is performed by the microwave device 100 according to the present embodiment.

FIG. 11 illustrates the waveforms of the I channel signal (I signal) and the Q channel signal (Q signal) for an approaching or receding motion of the moving body 9 (a person) with respect to the microwave device 100. The waveforms have both plus (+) amplitude components and minus (−) amplitude components with respect to the zero line. In approaching, the phase of the I channel signal goes ahead of the phase of the Q channel signal. In receding, in contrast, the phase of the I channel signal goes behind of the phase of the Q channel signal.

That is, when the I channel signal crosses the zero line at a change from minus to plus (the zero cross point, A1 in FIG. 11), if the Q channel signal is a minus signal, approaching is determined. In contrast, when the I channel signal crosses the zero line at a change from minus to plus (zero cross point, A2 in FIG. 11), if the Q channel signal is a plus signal, receding is determined.

<Determination of Approaching or Receding from a Signal Curve in the IQ Complex Plane>

Instead of determination of approaching or receding based on the progress of the I channel signal and the Q channel signal at the zero cross point, approaching or receding may be determined on the basis of a signal curve in the IQ complex plane, as described below.

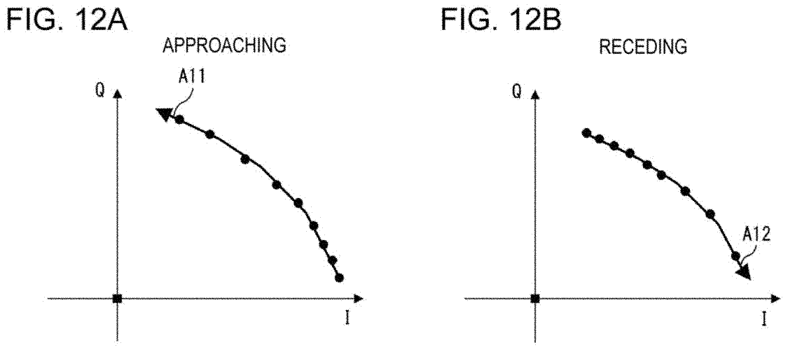

FIG. 12A is a diagram illustrating determination of approaching by using a signal curve in the IQ complex plane on the basis of the principle illustrated in FIG. 11. FIG. 12B is a diagram illustrating determination of receding by using a signal curve in the IQ complex plane on the basis of the principle illustrated in FIG. 11. FIGS. 12A and 12B are diagrams illustrating the I signal Cti and the Q signal Ctq, which are obtained from the moving body 9 (a person) approaching or receding with respect to the microwave device 100, as black circles plotted in the IQ complex plane at every given time (sampling time).

The IQ plane, which is a complex plan view, is formed of the I axis (in-phase axis), which is the horizontal axis, and the Q axis (quadrature phase axis), which is the vertical axis. FIG. 12A illustrates the state in which the moving body 9 approaches the microwave device 100. FIG. 12B illustrates the case in which the moving body 9 recedes from the microwave device 100.

In FIG. 12A, the arrow A11 in the counterclockwise direction indicates the direction of the track of the I signal Cti and the Q signal Ctq in the coordinates of the IQ plane in the case where the moving body 9 approaches the microwave device 100. In FIG. 12B, the arrow A12 in the clockwise direction indicates the direction of the track in the coordinates of the IQ plane in the case where the moving body 9 recedes from the microwave device 100.

The MCU 145 calculates the direction of the track at each point. Specifically, the MCU 145 calculates the phase θ of reflected waves in the IQ plane at each sampling time. The phase θ is calculated through arc tan (Q signal Ctq/I signal Cti). The MCU 145 determines whether the phase θ at each point increases (counterclockwise (approaching)) or decreases (clockwise (receding)). On the basis of the direction of the track, the MCU 145 determines approaching or receding.

When the MCU 145 has a high arithmetic capability, the method of determination based on the direction of a signal curve in accordance with the phase in the IQ plane may be combined with the method of determination based on the phase relationship between the I signal and the Q signal. This combination increases the amount of computation, but enables approaching or receding to be determined with more accuracy.

Preferably, the combination of both the determination methods is used to determine approaching or receding in accordance with the sampling rate as follows. For example, approaching or receding is determined 50 times at every two milliseconds with a determination time of 0.1 second. Then, a majority decision is performed, and approaching or receding, which is determined 30 times or more, is desirably employed as the determination result. In this method, when the determination results obtained by using both the determination methods do not match each other, it is determined that no determination is made. Thus, determination of approaching or receding is discriminated from no determination (neither approaching nor receding) with more accuracy.

<The Moving-Body Detection Process>

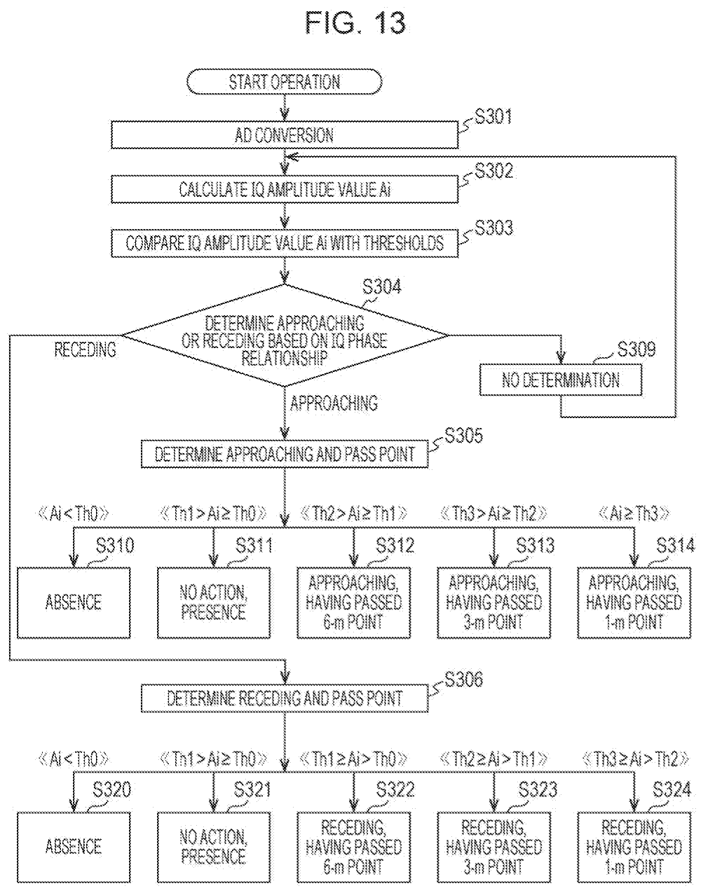

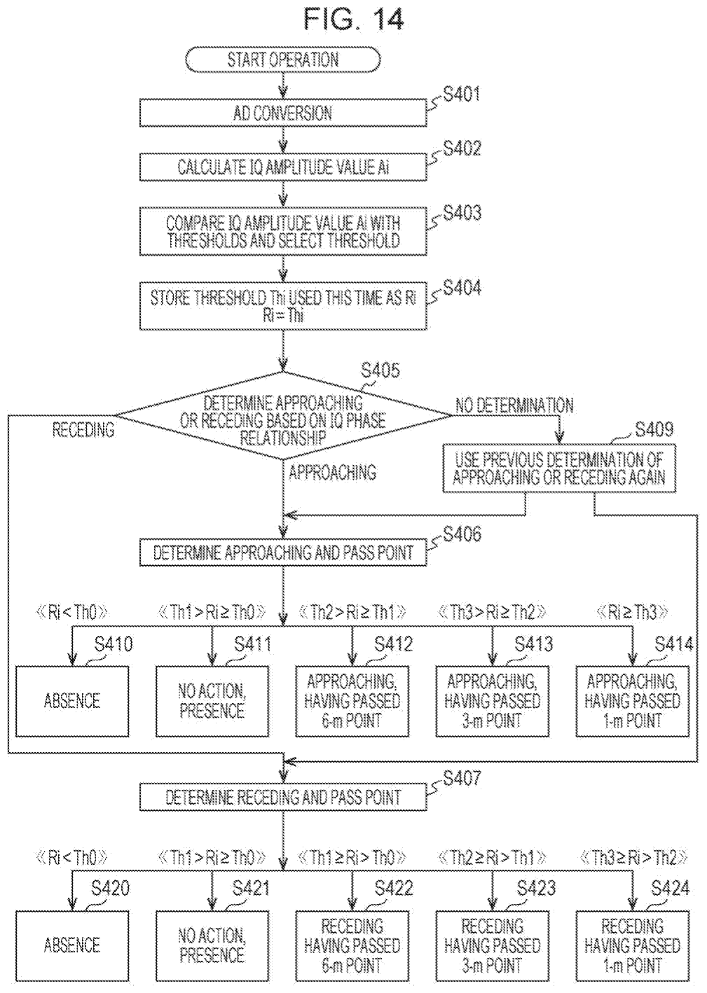

The process of detecting the moving body 9, which is performed by the microwave device 100, will be described. FIG. 13 is a flowchart of an operational procedure of a digital signal processor based on the principle illustrated in FIG. 11. FIG. 14 is a flowchart of another operational procedure of a digital signal processor based on the principle illustrated in FIG. 11.

As illustrated in FIG. 13, steps S301 to S303 are the same processes as steps S101 to S103 in the flowchart in FIG. 6.

The determination unit 153 of the arithmetic processor 160 determines whether the moving body 9 is approaching or receding, on the basis of the phase relationship between the I signal and the Q signal illustrated in FIG. 11 (step S304). In step S304, if the determination unit 153 determines approaching, the determination unit 153 performs determination as to approaching and the pass point (step S305). In step S304, if the determination unit 153 determines receding, the determination unit 153 performs determination as to receding and the pass point (step S306).

In step S305, the determination unit 153 performs five types of determination as to approaching on the basis of the relationship between the obtained IQ amplitude value Ai and the thresholds Th0 to Th3 (steps S310 to S314). These processes are the same processes as steps S110 to S114, respectively, in FIG. 6.

In step S306, the determination unit 153 performs five types of determination as to receding on the basis of the relationship between the obtained IQ amplitude value Ai and the thresholds Th0 to Th3 (steps S330 to S334). These processes are the same as steps S220 to S224, respectively, in FIG. 6.

In step S304, if the determination unit 153 determines neither approaching nor receding, the determination unit 153 performs neither determination of approaching or receding nor determination of the pass point (step S309). In this case, the process proceeds to step S302 in the next process.

As described above, in the present embodiment, the determination method based on the phase relationship between the I signal and the Q signal is combined with the process according to the first embodiment (see FIG. 6). As illustrated in FIG. 14, the determination method based on the phase relationship between the I signal and the Q signal may be combined with the process according to the second embodiment (see FIG. 10). The combined process will be described below.

As illustrated in FIG. 14, steps S401 to S404 are the same processes as steps S201 to S204, respectively, in the flowchart in FIG. 10.

Like the process in step S304 described above, the determination unit 153 determines whether the moving body 9 is approaching or receding, on the basis of the phase relationship between the I signal and the Q signal (step S405). If approaching is determined, the comparison unit 152 performs determination as to approaching and the pass point (step S406). If receding is determined, the comparison unit 152 performs determination as to receding and the pass point (step S407). In step S406, the determination unit 153 performs five types of determination as to approaching on the basis of the relationship between the obtained reference threshold Ri and the thresholds Th0 to Th3 (steps S410 to S414). These processes are the same as steps S210 to S214 in FIG. 10.

In step S407, the determination unit 153 performs five types of determination as to receding on the basis of the relationship between the obtained reference threshold Ri and the thresholds Th0 to Th3 (steps S420 to S424). These processes are the same as steps S220 to S224 in FIG. 10.

In step S405, if the determination unit 153 determines neither approaching nor receding, the determination unit 153 uses the determination result in the previous process again (step S409). In this case, if the determination result in the previous process indicates approaching, the process proceeds to step S406. If the determination result in the previous process indicates receding, the process proceeds to step S407.

### Effects of the Embodiment

As described above, when an approaching or receding person changes their walking speed, stops, or turns around while the person is walking, the IQ amplitude value Ai detected by the microwave device 100 increases and decreases. Thus, it is difficult to detect instantaneously whether the person is approaching or receding, only from an increase or decrease of the IQ amplitude value Ai. In contrast, in the present embodiment, the method of determining approaching or receding on the basis of the phase relationship between the I signal and the Q signal is combined with the determination method according to the first or second embodiment. This enables whether the moving body 9 is approaching or receding to be always determined instantaneously.

In addition, in determination of approaching or receding based on the IQ amplitude value Ai, averaging IQ amplitude values Ai, which are obtained through (fast) sampling, and using a directivity antenna improve noise immunity. However, in multi-reflection environment with indoor propagation of radio waves, influence of, for example, noise due to unnecessary reflection is not negligible, failing to eliminate influence on the IQ amplitude value Ai. Accordingly, use of the determination method based on the phase relationship between the I signal and the Q signal, which does not receive influence from a change in the IQ amplitude value Ai, may increase accuracy of determination of approaching or receding. In this determination method, determination may be made by combining the phase determination method with the method using an increase/decrease in the IQ amplitude value Ai.

### Fourth Embodiment

A fourth embodiment of the present invention will be described below by referring to FIGS. 1, 2, 5, and 15. For convenience of description, components having the same functions as those in the first and second embodiments are designated with the same reference numerals, and will not be described.

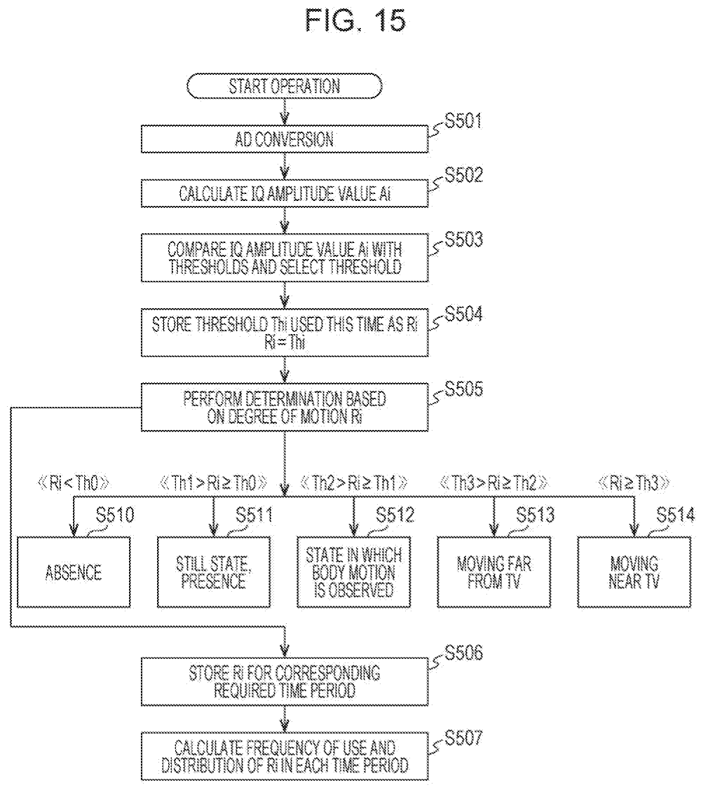

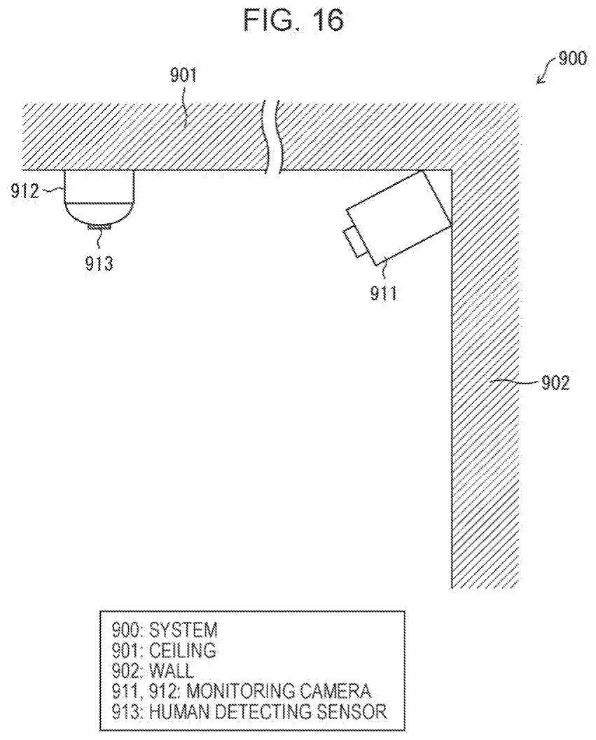

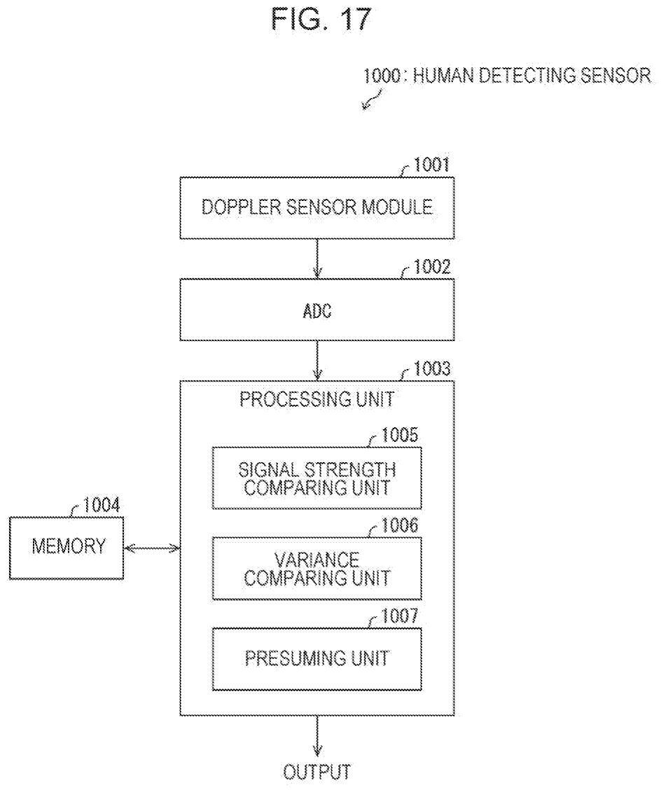

Like the microwave device 100 according to the first embodiment, the microwave device 100 according to the present embodiment has the configuration illustrated in FIGS. 1 and 2. Like the first embodiment, but excluding a part of it, the microwave device 100 according to the present embodiment determines approaching or receding and the pass point. In the present embodiment, functions different from those in the first and second embodiments will be described by referring to FIG. 15.

The microwave device 100 according to the present embodiment has a configuration so as to be used, not in determination of the pass point of the moving body 9 in the first to third embodiments, but in detection of the amount of activity of a person who is present indoors and detection of a person. For example, the microwave device 100 is installed, for example, at a high position on a wall, in a surrounding area of the display of a TV or the like, on the body of the air conditioner (indoor equipment), in a surrounding area of an air conditioner, or on a lighting fixture.

<The Moving-Body Detection Process>

The process of detecting the moving body 9, which is performed by the microwave device 100, will be described. FIG. 15 is a flowchart of an operational procedure of a digital signal processor of the microwave device 100 according to the present embodiment.

As illustrated in FIG. 15, steps S501 to S504 are the same processes as steps S201 to S204, respectively, in the flowchart in FIG. 10. However, unlike the determination of the pass point in the first to third embodiments, the threshold table 155 includes thresholds as illustrated in Table 2. The thresholds Thi to Th3 are preferably set as averages obtained by performing operations multiple times repeatedly.

In contrast, in setting the threshold Th0, it is necessary to calculate the indoor noise level in advance in the state in which no persons are present. The noise level is caused by influence from reflection of radio waves from walls, the ceiling, the floor, and the like, and changes depending on the room size. Thus, the noise level is determined in advance in a room in which motions of the moving body 9 are to be detected. The threshold Th0 is set to a value obtained by providing a margin in accordance with the noise level. This enables an optimal threshold to be determined in accordance with the room size. Thus, the threshold Th0 may be set with the optimal sensitivity.

TABLE 2

| Threshold | Value |
|---|---|
| Th0 | K0: 400 |
| Th1 | K1: 1000 |
| Th2 | K2: 3000 |
| Th3 | K2: 6000 |

In step S504, the comparison unit 152 stores the reference threshold Ri, which has been obtained this time, in the memory 154 (step S504). Then, the determination unit 153 uses the reference threshold Ri as the degree of motion of the moving body 9, and performs five types of determination, which are indicated by (1) to (5) described below, as to the state of the moving body 9 on the basis of the magnitude relationship with the four thresholds Th0 to Th3 described above (steps S510 to S514). The determination unit 153 displays the determination result on a display apparatus (not illustrated), and stores the determination result as data in the memory 154. Prior to step S505, the comparison unit 152 compares the reference threshold Ri with the thresholds Th0 to Th3.

(1) Ri<Th0: absence (step S510)

(2) Th1>Ri≥Th0: presence, in the still state, resting (step S511)

(3) Th2>Ri≥Th1: presence, the state in which a body motion is observed (step S512)

(4) Th3>Ri≥Th2: moving at a position far from a TV (step S513)

(5) Ri≥Th3: moving near a TV (step S514)

The determination unit 153 stores the reference threshold Ri, which is used this time, in the memory 154 for a corresponding required time period (step S506). The determination unit 153 calculates the frequency of use and the distribution of the reference thresholds Ri in each time period.

### Effects of the Embodiment

As described above, the microwave device 100 according to the present embodiment stores (holds) obtained thresholds all the time, and calculates the frequency of use, the distribution, and the like of the thresholds in each required time period. This enables the amount of activity of a person in the room to be estimated. Specifically, when only one person is present in a room, the microwave device 100 may be used as having a watching function. When multiple persons are present in a living room or a room of, for example, a hotel, the microwave device 100 not only may detect absence or presence, but also may estimate the amount of activity of the persons (the resting state or the actively-moving state) on the basis of the frequency of use or the distribution of the thresholds calculated in each required time period.

Preferably, the microwave device 100 is installed near the display of a TV. Typically, a TV is installed on the wall side in a living room, a private room, a bedroom, a hotel, a nursing home, or the like. Thus, the microwave device 100 that is installed near a TV may view the room in a broad angle as a monitoring point in the room, and a person tends to move such that the TV is located at the center.

As described above, the microwave device 100 may be installed on another household electrical appliance or directly on the wall side.

As another application, in a department store, a mass retailer, a public facility, or the like, the microwave device 100 is attached next to sale products or an important object to estimate the amount of activity of persons. This enables estimation of how often a person approaches the microwave device 100, on the basis of the frequency of use of the obtained thresholds. In addition, the following system may be configured: the frequency of use of thresholds is monitored at appropriate time intervals; when the frequency of use is higher than a specific value, an alarm is raised. This enables the state, in which a customer remains at the location, to be determined. Accordingly, a salesclerk may hurry to the location for addressing the trouble.

The four planar antennas 125 and the four planar antennas 130 are arranged in the longitudinal direction (see FIG. 4) so that the microwave device 100b has broad directivity in the horizontal direction, and has narrow directivity in the elevation-angle direction. That is, when the microwave device 100b is used as a human detecting sensor, the microwave device 100b may be disposed such that reflection from the ceiling or walls is also used efficiently.

Accordingly, a directional characteristic broader than the radiation angle obtained from the radiation pattern of the planar antennas 125 and 130 themselves may be obtained indoors. Specifically, even in a room (14 m×7 m) having a width of 10 m or more in the longitudinal direction of the microwave device 100, a single microwave device 100b may cover the entire area of the room.

[Additional Statement]

The present invention is not limited to the embodiments described above. In the scope indicated by the claims, various changes may be made. An embodiment obtained by appropriately combining technical means disclosed in different embodiments with each other is encompassed in the technical scope of the present invention. Further, combining technical means disclosed in the embodiments with each other may form novel technical characteristics.

[Implementation Example Using Software]

A control block (especially, the arithmetic processor 160) of the microwave device 100 may be implemented by using a logic circuit (hardware) formed in an integrated circuit (IC chip) or the like, or may be implemented by using software.

In the latter case, the microwave device 100 includes a computer which executes program instructions which are software for implementing the functions. For example, the computer includes at least one processor (control device) and includes at least one computer-readable recording medium in which the program is stored.

The processor of the computer reads, for execution, the program from the recording medium, achieving the object of the present invention. As the processor, for example, a CPU (Central Processing Unit) may be used.

As the recording medium, a “non-transitory tangible medium”, for example, the memory 154 which may include a ROM (Read Only Memory), a tape, a disk, a card, a semiconductor memory, or a programmable logic circuit, may be used. The memory 154 may include a RAM (Random Access Memory) or the like in which the program is loaded.

The program may be supplied to the computer through any transmission medium (such as a communication network or broadcast waves) through which the program is capable of being transmitted. An aspect of the present invention may be implemented also in the form of data signals in which the program is implemented through electronic transmission and which are embedded in carrier waves.

[Additional Statement]

The present invention is not limited to the embodiments described above. In the scope indicated by the claims, various changes may be made. An embodiment obtained by appropriately combining technical means disclosed in different embodiments with each other is encompassed in the technical scope of the present invention. Further, combining technical means disclosed in the embodiments with each other may form novel technical characteristics.

### REFERENCE SIGNS LIST

9 moving body (target)
25 transmit antenna (antenna)
30 receive antenna (antenna)
100, 100a, 100b microwave device 100 (radio-frequency device)
125, 130 planar antenna (antenna)
150 radio-frequency transmitting/receiving unit
151 amplitude-value calculating unit (amplitude-value detecting unit)
152 comparison unit
153 determination unit
Ai IQ amplitude value (first amplitude value)
Ai-1 IQ amplitude value (second amplitude value)
Ri reference threshold (reference threshold, first reference threshold)
Ri-1 reference threshold (reference threshold, second reference threshold)

1. A radio-frequency device comprising:
an amplitude-value detecting unit that detects a motion of a target as an amplitude value at a given time interval in accordance with a difference between a frequency of a radiation wave and a frequency of a reflected wave, the radiation wave being emitted to the target, the reflected wave being reflected from the target;
a comparison unit that compares a first amplitude value with a second amplitude value, the first amplitude value being the amplitude value detected this time, the second amplitude value being the amplitude value detected a previous time, and compares the first amplitude value with a plurality of thresholds that are set in advance; and
a determination unit that determines whether the target is approaching or receding on the basis of a magnitude relationship between the first amplitude value and the second amplitude value, and that determines a first-amplitude-value position as a position which the target has passed, the first-amplitude-value position being a position at which the first amplitude value is present and being determined in terms of ranges defined by using a minimum, a maximum, and adjacent two values of the plurality of thresholds.

2. A radio-frequency device comprising:
an amplitude-value detecting unit that detects a motion of a target as an amplitude value at a given time interval in accordance with a difference between a frequency of a radiation wave and a frequency of a reflected wave, the radiation wave being emitted to the target, the reflected wave being reflected from the target;
a comparison unit that compares the amplitude value with a plurality of thresholds so as to select a maximum threshold among the plurality of thresholds as a reference threshold, the plurality of thresholds being set in advance, the maximum threshold being exceeded by the amplitude value, and that compares a first reference threshold with a second reference threshold, the first reference threshold being the reference threshold selected this time, the second reference threshold being the reference threshold selected a previous time; and
a determination unit that determines whether the target is approaching or receding on the basis of a magnitude relationship between the first reference threshold and the second reference threshold, and that determines a first-reference-threshold position as a position which the target has passed, the first-reference-threshold position being a position at which the first reference threshold is present and being determined in terms of ranges defined by using a minimum, a maximum, and adjacent two values of the plurality of thresholds.

3. The radio-frequency device according to claim 1,
wherein the determination unit uses the amplitude value obtained by using an average or a root mean square at a given distance interval, so as to set the plurality of thresholds, and determines a position passed by the target, on the basis of the thresholds.

4. The radio-frequency device according to claim 1,
wherein the determination unit determines whether the target is approaching or receding on the basis of a phase relationship between an I signal and a Q signal which indicate a motion of the target.

5. The radio-frequency device according to claim 1,
wherein the determination unit holds the thresholds used in determination, and detects a frequency of use of the thresholds in each given time period to determine an amount of activity of the target instead of determination as to whether the target is approaching or receding and determination of a passed position of the target.

6. The radio-frequency device according to claim 1,
wherein a band lower than the amplitude value is 0.1 Hz and higher.

7. The radio-frequency device according to claim 1, further comprising:
an antenna that has directivity, in which a strong transmit wave is emitted in a traveling direction of the target, so as to emit the transmit wave directly to the target.

8. The radio-frequency device according to claim 7,
wherein the antenna has broad directivity in a horizontal direction and has narrow directivity in an elevation-angle direction.

9. The radio-frequency device according to claim 7,
wherein the antenna has narrow directivity in a horizontal direction and has broad directivity in an elevation-angle direction.

10. The radio-frequency device according to claim 2,
wherein the determination unit uses the amplitude value obtained by using an average or a root mean square at a given distance interval, so as to set the plurality of thresholds, and determines a position passed by the target, on the basis of the thresholds.

11. The radio-frequency device according to claim 2,
wherein the determination unit determines whether the target is approaching or receding on the basis of a phase relationship between an I signal and a Q signal which indicate a motion of the target.

12. The radio-frequency device according to claim 2,
wherein the determination unit holds the thresholds used in determination, and detects a frequency of use of the thresholds in each given time period to determine an amount of activity of the target instead of determination as to whether the target is approaching or receding and determination of a passed position of the target.

13. The radio-frequency device according to claim 2,
wherein a band lower than the amplitude value is 0.1 Hz and higher.

14. The radio-frequency device according to claim 2, further comprising:
an antenna that has directivity, in which a strong transmit wave is emitted in a traveling direction of the target, so as to emit the transmit wave directly to the target.

15. The radio-frequency device according to claim 14,
wherein the antenna has broad directivity in a horizontal direction and has narrow directivity in an elevation-angle direction.

16. The radio-frequency device according to claim 14,
wherein the antenna has narrow directivity in a horizontal direction and has broad directivity in an elevation-angle direction.
